(19) United States
(12) Patent Application Publication
(10) Pub. No.: US 2009/0028117 A1
(43) Pub. Date: Jan. 29, 2009

(54) PROVIDING NETWORK CONNECTIVITY AND SERVICE STATE INFORMATION TO APPLICATION SERVERS

(75) Inventors: Walter P. Goulet, Chicago, IL (US); Luis G. Roriguez Chiappetta, Greensboro, NC (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/781,466

(22) Filed: Jul. 23, 2007

(51) Int. Cl. H04Q 7/24

(52) U.S. Cl. 370/338

(57) ABSTRACT

A method (200, 300) of tracking remote unit (102, 104, 106, 108) state information. The method can include, for a remote unit communicatively linked to an access service network (ASN) (112, 114), identifying a state change from a first state to a second state. Responsive to identifying the state change, an outbound message indicating the second state can be communicated to a carrier service network (CSN) (110). In another arrangement, responsive to identifying the state change, an indicator that indicates state information associated with the remote unit is available can be published by the ASN or the CSN.

### BACKGROUND OF THE INVENTION

1. Field of the Invention

The present invention generally relates to communication networks and, more particularly, to communication networks which host applications for use by remote clients.

2. Background of the Invention

An IEEE 802.16e based communication system (e.g., WiMAX) may comprise two distinct types of network domains, namely an access service network (ASN) and a carrier service network (CSN). An ASN typically will include a plurality of base stations that provide transport connectivity to remote units (e.g., mobile stations), and an ASN gateway through which the ASN interfaces with the CSN. The CSN may connect the ASN to other communication networks, such as the Internet and a public switched telephone network (PSTN), as well as host application servers that provide applications and services to the remote units. Further, the CSN can interface with multiple ASNs, thereby providing service to a large number of remote units.

Various types of data may be exclusively stored in the ASN or the CSN. For example, the network status of remote units may be maintained in the ASN, while billing and authentication records may be stored in the CSN. Thus, an ASN operator may need to rely on usage records from the CSN in order to determine a level of ASN network activity. Further, the CSN may be unaware of the remote unit's network status (e.g., location and state of the remote unit), and thus may be unable to provide certain applications to the remote unit, for instance location specific applications. Moreover, the CSN may experience unanticipated delays when delivering data to a remote unit if the remote unit happens to be in a state other than active.

### SUMMARY OF THE INVENTION

The present invention relates to a method of tracking remote unit state information. The method can include, for a remote unit communicatively linked to an access service network (ASN), identifying a state change from a first state to a second state. Responsive to identifying the state change, an outbound message indicating the second state can be communicated to a carrier service network (CSN). In another arrangement, responsive to identifying the state change, an indicator that indicates state information associated with the remote unit is available can be published by the ASN.

In another aspect of the present invention, for a remote unit communicatively linked to an access service network (ASN), an inbound message indicating a current state of the remote unit can be received at a carrier service network (CSN). An indicator that indicates state information associated with the remote unit is available can be published by the CSN.

The present invention also can be embedded in a program storage device readable by a machine, tangibly embodying a program of instructions executable by the machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts a flow chart that is useful for understanding the present invention; and

FIG. 3 depicts another flow chart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method and a system for tracking state information of a remote unit that is communicatively linked to an access service network (ASN) and making the state information available to a carrier service network (CSN). In addition, information pertaining to the remote unit's use of CSN resources can be tracked and made available to the ASN. Thus, an ASN operator need not rely on usage records from the CSN in order to determine a level of ASN network activity. Moreover, the CSN can maintain awareness of the remote unit's network status, and thus selectively optimize delivery of data to the remote unit based upon the remote unit's current state.

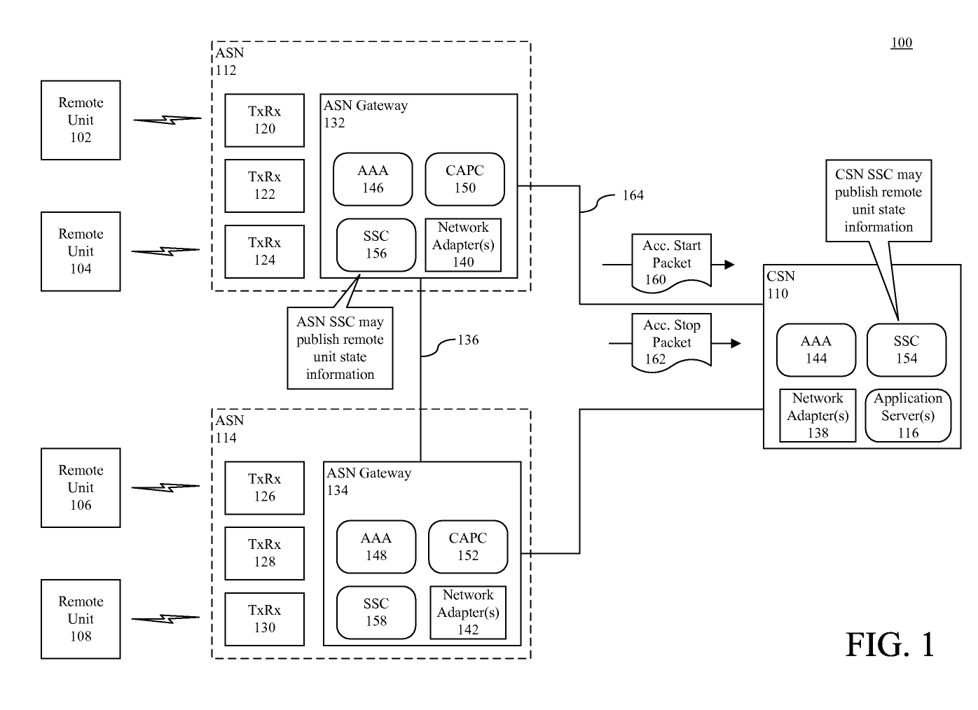

FIG. 1 depicts a communications system 100 that is useful for understanding the present invention. The communications system 100 can be implemented in accordance with one or more applicable wireless communications and air interface standards. Examples of such standards include, but are not limited to, Institute of Electrical and Electronics Engineers (IEEE) 802 wireless communications, for example, 802.11 and 802.16 (e.g. WiMAX), standards proposed by the Open Mobile Alliance (OMA), the 3rd Generation Partnership Project (3GPP), and/or the 3rd Generation Partnership Project 2 (3GPP2). The communications system 100 also can implement any of a variety of communication protocols including, but not limited to, GSM, TDMA, CDMA, WCDMA, OFDM, etc. Modifications or deviations from the standards and/or protocols can be made to suitably implement the present invention.

The communications system 100 can include one or more remote units 102, 104, 106, 108. The remote units 102-108 can be, for instance, mobile stations (e.g., mobile telephones, mobile radios, mobile computers, personal digital assistants, or the like), computers, wireless gaming devices, access terminals, subscriber stations, user equipment, or any other devices suitably configured to communicate via a wireless communications network. As such, the remote units 102-108 can comprise one or more processors/controllers, transceivers, and/or other suitable components.

The communications system 100 can include a CSN 110 and one or more ASNs 112, 114. The CSN 110 can be registered with application servers 116 that, via the ASNs 112, 114, provide applications and services that are available to the remote units 102-108. Examples of such applications and services can include, but are not limited to, communication services, messaging services, download services, global positioning services, gaming applications, and so on.

The ASNs 112-114 each can include one or more transceivers 120, 122, 124, 126, 128, 130 via which the ASNs 112-114 communicate with the remote units 102-108. In that regard, the transceivers 120-130 can modulate and demodulate signals to convert signals from one form to another, and can transmit and/or receive the signals over one or more various wireless communication networks. Such communication can be implemented in accordance with one or more communication protocols supported by the communications system 100. Examples of suitable transceivers 120-130 can include those that are implemented within base transceiver stations, repeaters or access points, but the invention is not limited in this regard as the ASNs 112, 114 can include any other suitable transceivers.

Each of the ASNs 112, 114 can include an ASN gateway 132, 134, each of which may include one or more network adapters 140, 142. The CSN 110 also can include a network adapter 138. The network adapters 138, 140, 142 can comprise, for example, communications modems, wired and/or wireless transceivers, or any other devices that may suitably communicate data over a communications network. In one arrangement, the ASNs 112, 114 can include a plurality of network adapters to support communications with the transceivers 120-130, inter-ASN communications via a backhaul communication link 136, and communications with an external communications network, such as a CSN 110. Similarly, the CSN 110 can comprise a plurality of network adapters to support communications with the ASNs 112, 114 and other communications systems.

The CSN 110 and each of the ASNs 112, 114 also may include respective authentication, authorization and accounting (AAA) servers 144, 146, 148. AAA servers also are known to those skilled in the art. The AAA server 144 can confirm whether a remote unit 102-108 is associated with a valid user of CSN network resources being requested by the remote unit, authorize access to specific types of CSN resources based on authentication of the user/remote unit, and track the user's/remote unit's consumption of CSN resources. Similarly, the AAA servers 146, 148 can confirm whether a remote unit 102-108 is associated with a valid user of ASN resources being requested by the remote unit, authorize access to specific types of ASN resources based on authentication of the user/remote unit, and track the user's/remote unit's consumption of ASN resources.

While the AAA server 144 can provide authentication, authorization and accounting services for any remote unit 102-108 attempting to access resources of the CSN 110, the AAA server 146 can selectively provide authentication, authorization and accounting services for those remote units whose anchor ASN is the ASN 112, and the AAA server 148 can selectively provide such services for those remote units whose anchor ASN is the ASN 114. Although the remote units 102-108 may connect to their anchor ASNs, while roaming the remote units 102-108 may connect to ASNs that are not their anchor ASNs. For example, if the ASN 112 is the anchor ASN for the remote unit 106, the remote unit 106 still may connect to the ASN 114 via the transceiver 126. Nonetheless, the AAA server 146 still may provide the authentication, authorization and accounting services for the remote unit 106 while the remote unit 106 is connected to the ASN 114. For example, messages can be communicated between the remote unit 106 and the ASN gateway 132 via the ASN gateway 134 and the backhaul communication link 136. If the communications system 100 implements WiMAX, the backhaul communication link 136 can be an R4 interface.

The CSN 110 and each of the ASN gateways 132, 134 also can include a session state controller 154, 156, 158 that is associated with a respective AAA server 144, 146, 148. In one arrangement, the session state controllers 156, 158 can maintain accounting records that indicate the connection states of the remote units 102-108 and/or indicate the remote units' use of network resources. For example, the session state controller 156 can maintain accounting records for the remote units whose anchor ASN is the ASN 112, and the session state controller 158 can maintain accounting records for the remote units whose anchor ASN is the ASN 114. In another arrangement, the accounting records can be maintained by the session state controller 154 associated with the CSN 110.

Each of the ASN gateways 132, 134 also may include a carrier access point controller 150, 152. The carrier access point controllers 150, 152 can receive messages which indicate the state of the respective remote units 102-108, for example the air interface connection state of the remote unit, whether the remote unit is using particular network resources, and so on. Such messages can be received from systems that comprise the transceivers 120-130, for instance base transceiver stations, base station controllers, access points, repeaters, and the like.

The carrier access point controller 150 can receive state indication messages for the remote units whose anchor ASN is the ASN 112, and the carrier access point controller 152 can receive state indication messages for the remote units whose anchor ASN is the ASN 114. By way of example, if the ASN 112 is the anchor ASN for the remote unit 106, the state indication messages can be communicated from the transceiver 126 to the carrier access point controller 150 via the ASN gateway 134, the backhaul communication link 136 and the ASN gateway 132.

The state indication messages can be received during a state change event on a remote unit 102-108 and/or after a remote unit state change has been completed. Examples of state change events include, but are not limited to, initiating or ending use of network resources and changing from a first air interface connection state to a second air interface connection state (e.g., changing from sleep mode to active mode, changing from active mode to sleep mode, initiating or ending a communication session, and so on). When a state change occurs in the remote unit 102, a system hosting a transceiver serving the remote unit, for example, transceiver 120, can communicate to the carrier access point controller 150 a message indicating the current state of the remote unit 102. Optionally, the message also can indicate the previous state of the remote unit 102. In addition to, or in lieu of, such message, the system hosting the transceiver 120 can communicate a state indication message to a carrier access point controller serving the remote unit, for example, carrier access point controller 150, when the state change of the remote unit 102 is complete. Such message also may indicate a previous state of the remote unit 102, though such indication need not be required.

The accounting records can be generated and maintained in any suitable manner. For example, when the remote unit 102 accesses one or more network resources (e.g., ASN resources or CSN resources), the carrier access point controller 150 can create a message and communicate the message to the corresponding session state controller 156. The message can be, for instance, an accounting start packet and can indicate the remote unit's state and/or indicate that the remote unit 102 is accessing the network resource.

In one aspect of the inventive arrangements, the accounting start packet can be a RADIUS accounting packet. RADIUS accounting packets are well defined message formats that are extensible and allow for the addition of desired values/indicators, for instance an indicator that represents a remote unit's state. Further, the use of RADIUS accounting packets can provide the ability to route messages among the AAA servers 144-148. For example, accounting packets can be routed from the AAA server 148 to the AAA server 146, from the AAA server 146 to the AAA server 144, and so on. In addition, hop-by-hop security can be implemented to authenticate RADIUS accounting packets communicated among the AAA servers. Notwithstanding, the invention is not limited to the use of RADIUS accounting packets; the accounting start packet can be formatted in accordance with any other suitable protocol(s).

In one arrangement, the session state controller 156 of the ASN 112 can communicate an accounting start packet 160 to the session state controller 154 of the CSN 110 via a communication link 164. If the communications system 100 implements WiMAX, the communication link 164 can be an R3 interface. In response to receiving the accounting start packet, the CSN session state controller 154 can generate a new accounting record to represent the network resource(s) use session.

When the remote unit 102 again changes state and/or ends its use of the network resource(s), another state indication message can be communicated from the transceiver 120 to the carrier access point controller 150 of ASN 112. In response, the carrier access point controller 150 can generate another message that indicates the remote unit's use of the network resource(s) has ceased and/or indicates the state of the remote unit 102. Such message can be an accounting stop packet, which also may be formatted as a RADIUS accounting packet, though this need not be the case. The accounting stop packet can be communicated to the session state controller 156 of ASN 112, which then can forward the accounting stop packet 162 to the session state controller 154 of CSN 110. The accounting start packet and/or accounting stop packet also may indicate a previous state of the remote unit 102, though such indication need not be required. In response to the stop packet, the session state controller 154 can finalize the newly generated accounting record such that the accounting record indicates the remote unit's state and/or its use of the network resource(s) during the use session.

The session state controller 154 of CSN 110 then can publish an indicator that indicates state information associated with the remote unit 102 is available. The indicator can be the accounting record itself or an identifier that identifies the accounting record. The ASNs 112, 114 and the application servers 116 can utilize the published indicator to access the accounting record from the session state controller 154 using a push/pull mechanism. For example, the session state controller 154 can store the accounting record in a database, which may be collocated with the session state controller 154 or located on another system with which the session state controller 154 may communicate. Using a pull mechanism, such as a database query, the database can be accessed to retrieve the accounting record. A process also can be instantiated on the session state controller 154 to publish (or push) a notification to interested parties when the accounting packet is otherwise available to be accessed. For instance, the notification can be generated when the session state controller 154 receives the accounting start packet 160 or the accounting stop packet 162, or when the accounting record is finalized.

In another arrangement, rather than communicating the accounting start/stop packets to the session state controller 154 of the CSN 110, the session state controller 156 of the ASN 112 can generate the new accounting record to represent the use session. When the remote unit 102 again changes state and/or ends its use of the network resource(s), the session state controller 156 can process the accounting stop packet to finalize the newly generated accounting record such that the accounting record indicates the remote unit's state and/or its use of the network resource(s) during the use session.

The session state controller 156 can store the accounting record in a database, which may be collocated with the session state controller 156 or located on another system with which the session state controller 156 may communicate. The session state controller 156 then can publish an indicator that indicates state information associated with the remote unit 102 is available. Again, the indicator can be the accounting record itself or an identifier that identifies the accounting record. In an arrangement in which the indictor is an identifier, the CSN 110 and application servers 116 can utilize the published indicator to access the accounting record from the session state controller 156, for example using database queries. In another arrangement, the session state controller 156 can monitor the accounting records database for updates and communicate a notification to the CSN 110 and/or application servers 116 when updates are available. The notification can be communicated, for example, using the session initiation protocol (SIP).

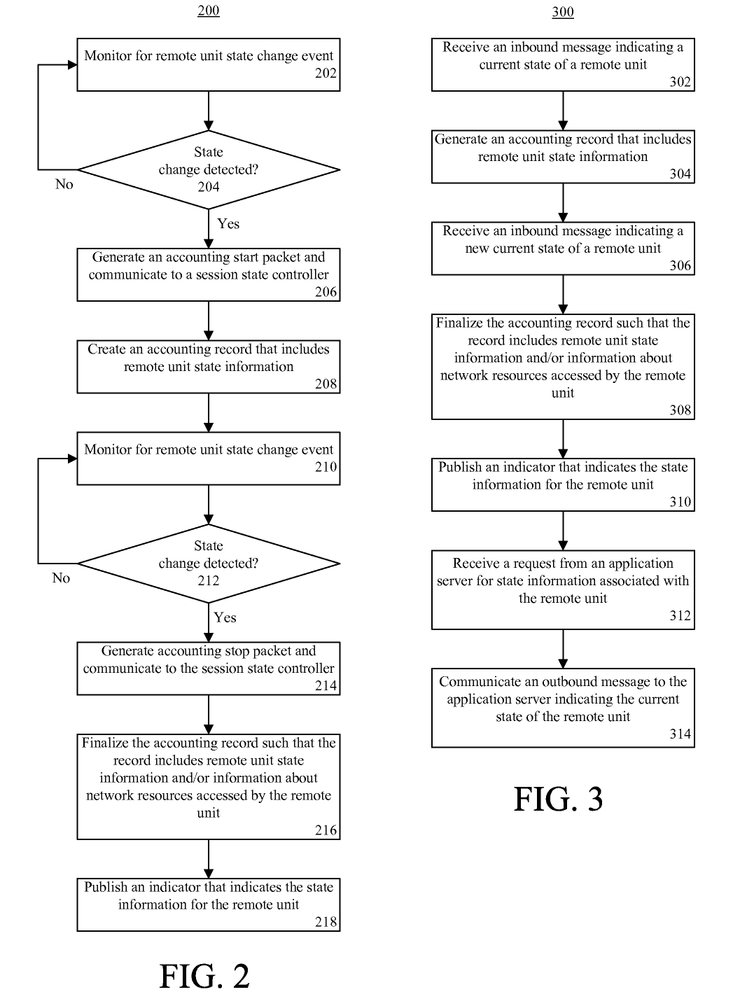

FIG. 2 depicts a flow chart that presents a method 200 that is useful for understanding the present invention. The method 200 can begin in a state in which a remote unit has established a communicative link with an ASN. Beginning at step 202, an ASN gateway can monitor for a remote unit state change event, for example a remote unit changing from a first air interface connection state to a second air interface connection state, initiating or terminating use of one or more network resources, etc. Referring to decision box 204, if a state change is detected, for example a carrier access point controller of the ASN receives a state indication message associated with a remote unit (e.g., from a base transceiver station, a base station controller, an access point, a repeater, etc.), the process can proceed to step 206.

At step 206, the carrier access point controller can generate an accounting start packet and communicate the start packet to an ASN session state controller. The accounting start packet can indicate the remote unit's state and/or indicate network resources accessed by the remote unit. As noted, the accounting start packet can be a RADIUS accounting packet. At step 208, the ASN session state controller can create an accounting record that includes the remote unit state information. Alternatively, the ASN can communicate the accounting start packet to a CSN state controller, which can create the accounting record.

At step 210, the ASN gateway can monitor for another remote unit state change event. If at decision box 212 a state change is detected, for instance the ASN carrier access point controller receives another state indication message associated with the remote unit, the process can proceed to step 214. At step 214 the carrier access point controller can generate an accounting stop packet and communicate the accounting stop packet to the ASN session state controller. If the ASN session state controller has created an accounting record for the remote unit's state information, at step 216 the ASN session state controller can finalize the accounting record such that the accounting record indicates the remote unit's state(s) and/or network resources accessed by the remote unit. If, however, the accounting record was created by the CSN session state controller, the ASN session state controller can forward the accounting stop packet to the CSN session state controller, and at step 216 the CSN session state controller can finalize the accounting record.

At step 218, an indicator that indicates the state information of the remote unit and/or the network resources accessed by the remote unit can be published by the session state controller that generated the accounting record (e.g., the ASN session state controller or the CSN session state controller). The indicator can be the accounting record that was generated, or a reference to such accounting record.

FIG. 3 depicts a flow chart that presents another method 300 that is useful for understanding the present invention. The method 300 can begin in a state in which a remote unit has established a communicative link with an ASN. Beginning at step 302, an inbound message can be received indicating a current state of a remote unit and/or network resources accessed by the remote unit. Proceeding to step 304, an accounting record that includes the remote unit's state information can be generated.

At step 306, an inbound message indicating a new current state of the remote unit can be received. In response, at step 308 the accounting record can be finalized such that the accounting record includes the remote unit's state information and/or information about network resources accessed by the remote unit. At step 310, an indicator that indicates the state information of the remote unit and/or the network resources accessed by the remote unit can be published. For example, the accounting record can be published or an identifier associated with the accounting record can be published.

In an arrangement in which the accounting record includes the remote state information, at step 312 a request from an application server for state information associated with the remote unit can be received. In response, at step 314 an outbound message can be communicated to the application server indicating the current state of the remote unit.

The block diagrams and signal flow diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method of tracking remote unit state information, comprising:
for a remote unit communicatively linked to an access service network (ASN), identifying a state change from a first state to a second state; and
responsive to identifying the state change, communicating an outbound message to a carrier service network (CSN) indicating the second state.

2. The method of claim 1, wherein communicating the outbound message to the CSN comprises communicating a RADIUS accounting packet to the CSN.

3. The method of claim 1, wherein communicating the outbound message to the CSN comprises communicating a RADIUS accounting packet to a session state controller of the CSN.

4. The method of claim 1, wherein communicating the outbound message to the CSN comprises:
generating, by the ASN, a RADIUS accounting packet; and
communicating the RADIUS accounting packet to a session state controller of the CSN.

5. The method of claim 1, wherein communicating the message to the CSN comprises communicating the message to a CSN that is registered with at least one application server which provides services available to the remote unit.

6. The method of claim 1, wherein identifying the state change comprises identifying a state change from a first air interface connection state to a second air interface connection state.

7. The method of claim 1, wherein identifying the state change from the first state to the second state comprises, at an ASN gateway, receiving an inbound message from a base station indicating the state change.

8. The method of claim 1, wherein identifying the state change from the first state to the second state comprises:
at an ASN gateway, receiving a first inbound message from a base station indicating the state change is in process; and
at the ASN gateway, receiving a second inbound message indicating the second state.

9. A method of tracking remote unit state information, comprising:
for a remote unit communicatively linked to an access service network (ASN), identifying a state change from a first state to a second state; and
responsive to identifying the state change, from the ASN publishing an indicator that indicates state information associated with the remote unit is available.

10. The method of claim 9, further comprising communicating a RADIUS accounting packet to a session state controller.

11. The method of claim 9, further comprising:
generating, by the ASN, a RADIUS accounting packet; and
from a carrier access point controller of the ASN, communicating the RADIUS accounting packet to a session state controller of the ASN.

12. The method of claim 9, wherein publishing the indicator comprises generating an accounting record for the remote unit.

13. The method of claim 9, wherein identifying the state change comprises identifying a state change from a first air interface connection state to a second air interface connection state.

14. The method of claim 9, wherein identifying the state change from the first state to the second state comprises, at an ASN gateway, receiving an inbound message from a base station indicating the state change.

15. The method of claim 9, wherein identifying the state change from the first state to the second state comprises:
at an ASN gateway, receiving a first inbound message from a base station indicating the state change is in process; and
at the ASN gateway, receiving a second inbound message indicating the second state.

16. A method of tracking remote unit state information, comprising:
for a remote unit communicatively linked to an access service network (ASN), at a carrier service network (CSN) receiving an inbound message indicating a current state of the remote unit; and
from the CSN, publishing an indicator that indicates state information associated with the remote unit is available.

17. The method of claim 16, wherein receiving the inbound message further comprises receiving an indication of a previous state of the remote unit.

18. The method of claim 16, wherein publishing the indicator comprises publishing the indicator via a session state controller of the CSN.

19. The method of claim 16, further comprising generating an accounting record for the remote unit.

20. The method of claim 16, further comprising:
receiving a request from an application server for state information associated with the remote unit; and
responsive to the request, communicating an outbound message to the application server indicating a current state of the remote unit.
